(19) United States
(12) Patent Application Publication
(10) Pub. No.: US 2026/0327073 A1
(43) Pub. Date: Oct. 22, 2026

(54) PROCESS FOR THE CONTINUOUS PRODUCTION OF HYDROGEN PEROXIDE FROM DI-ISOPROPYL ETHER USING SEQUENTIAL OXIDATION AND HYDROLYSIS MODULES

(71) Applicant: Sachin Surendra, Richmond Hill, NY (US)

(72) Inventor: Sachin Surendra, Richmond Hill, NY (US)

(21) Appl. No.: 19/181,292

(22) Filed: Apr. 16, 2025

(51) Int. Cl. C01B 15/022; B01D 3/14; B01J 19/12; B01J 19/24; B01J 27/25; B01J 27/28; B01J 31/04; B01J 31/40

(52) U.S. Cl. CPC C01B 15/022; B01D 3/14; B01J 19/123; B01J 19/245; B01J 27/25; B01J 27/28; B01J 31/04; B01J 31/4015; B01J 2219/0884

(57) ABSTRACT

Disclosed is a continuous process for producing hydrogen peroxide (H₂O₂) from di-isopropyl ether via a sequential modular system. In one embodiment, di-isopropyl ether is prepared from isopropyl alcohol by acid-catalyzed dehydration with continuous fractional distillation using a fractionating column. The di-isopropyl ether is then oxidized in a reactor maintained at 25 °C to 30 °C while ambient air is sparged at 8-12 mL/min per every 10 mL of solution in the presence of a catalyst system comprising cobalt salts (0.25-0.3 mM), manganese salts (approximately 0.25 mM), and a halide additive (0.1-0.2 mM). Optionally, a quartz mercury UVC lamp irradiates the reactor to generate reactive oxygen species that enhance initiation. The resulting hydroperoxide is hydrolyzed by controlled dropwise addition of deionized water (0.5-1.0 mL/10 mL) under mildly acidic conditions (at a pH 4-5), yielding H₂O₂ with high selectivity and minimal byproducts.

### BACKGROUND

Hydrogen peroxide is widely utilized in applications including disinfection, bleaching, organic synthesis, and environmental treatment. Traditional methods—such as the anthraquinone process—require centralized, capital-intensive operations. Those skilled in the art are familiar with such approaches, as well as with alternative processes, including the direct oxidation of isopropyl alcohol. For example, U.S. Pat. No. 2,871,103 (Skinner) describes a detailed liquid-phase, noncatalytic oxidation of secondary alcohols but suffers from excessive formation of organic acids and other byproducts. Similarly, U.S. Pat. No. 4,547,354 (Pinault), U.S. Pat. No. 3,737,518 (Bonetti), and U.S. Pat. No. 3,891,748 (Rosenthal) disclose acid-catalyzed hydrolysis processes for organic hydroperoxides—commonly tertiary butyl hydroperoxide—with continuous approaches that are limited by selectivity and complications in separating undesired reaction products.

Furthermore, the non-patent literature by A. R. Burgess discusses the gaseous oxidation of isopropyl alcohol at elevated temperatures (350°-450 °C) and underscores the significant impact of reactor surface properties and contact time on hydrogen peroxide yield and stability. Although Burgess deals with a gas-phase system, his findings regarding reaction kinetics and the influence of surface area reinforce the need for controlled reaction conditions—a challenge addressed by our invention through the use of di-isopropyl ether as an intermediate coupled with sequential modular processing at lower temperatures.

Thus, despite significant prior art, a method that employs di-isopropyl ether as an intermediate feedstock and divides the production into discrete, optimized modules is needed. The present invention satisfies this need by offering improved conversion, higher selectivity for hydrogen peroxide, and simplified, low-capital operation suitable for field deployment.

### SUMMARY OF THE INVENTION

In one embodiment, the present invention provides a continuous process for producing hydrogen peroxide comprising the following sequential modules:

Feedstock Synthesis Module: Isopropyl alcohol is dehydrated in the presence of a strong acid (e.g., concentrated sulfuric acid modified with acetic acid) and continuously distilled using a Fractionating column. Di-isopropyl ether, having a boiling point within the range of 68 °C to 72 °C (preferably within the range of 68.5 °C to 71.5 °C), is thereby separated and collected. Continuous removal of the ether shifts the equilibrium toward complete conversion of the isopropyl alcohol feed, as described in prior art (cf. Skinner).

Oxidation Module: The di-isopropyl ether is introduced into an oxidation reactor maintained at a temperature within the range of 25 °C to 30 °C (preferably within the range of 26 °C to 29 °C). Ambient air is sparged into the reactor at a flow rate within the range of 8 mL/min to 12 mL/min (preferably 10 mL/min). A catalyst system is employed comprising cobalt salts (0.2-0.5 mM, preferably 0.25-0.3 mM), manganese salts (preferably ~0.25 mM), and a halide additive (0.1-0.3 mM, preferably 0.1-0.2 mM). In a preferred embodiment, this module further incorporates a quartz mercury UVC lamp that irradiates the reaction mixture, facilitating the generation of reactive oxygen species to augment the initiation and rate of the autooxidation reaction.

Under these conditions, the di-isopropyl ether is oxidized to form a hydroperoxide intermediate, with the catalyst system and controlled conditions minimizing the formation of unwanted byproducts, as compared to methods taught in U.S. Pat. Nos. 3,891,748 and 2,871,103.

Hydrolysis Module: The hydroperoxide intermediate is then rapidly hydrolyzed by controlled, dropwise addition of deionized water. The total volume of water added is maintained within the range of 0.5 mL to 1.0 mL per 10 mL of reaction mixture (preferably 0.75 mL). The hydrolysis is conducted under mildly acidic conditions, with the pH maintained within the range of 4 to 5 (preferably within the range of 4.2 to 4.8), thereby converting the intermediate to hydrogen peroxide with minimal side reactions.

Separation and Recovery Module: The resulting reaction mixture, which forms a biphasic system, is allowed to settle so that the aqueous phase—enriched in hydrogen peroxide—can be separated from the residual organic phase. The aqueous phase may then be optionally concentrated by low-temperature evaporation under reduced pressure. Catalyst reagents can be recovered by pH adjustment to precipitate metal hydroxides for recycling.

By employing di-isopropyl ether as an intermediate and dividing the process into discrete, controlled modules, the present invention achieves improved selectivity and conversion for hydrogen peroxide, while substantially lowering the formation of byproducts such as acetone and isopropanol. This approach further simplifies the process, making it suitable for field-deployable, low-capital applications—a significant advance over the methods disclosed in the cited prior art.

### DETAILED DESCRIPTION OF THE INVENTION

The present invention provides a robust and efficient continuous process for producing hydrogen peroxide through a sequential modular system. Detailed embodiments and exemplary operating parameters are described below.

### A. Feedstock Synthesis Module

In the initial module, isopropyl alcohol is dehydrated in the presence of a strong acid catalyst, preferably concentrated sulfuric acid modified with acetic acid. This reaction is carried out at approximately 80 °C. A Fractionating column is employed to continuously distill the di-isopropyl ether as it forms. By maintaining the di-isopropyl ether at a boiling point within the range of 68 °C to 72 °C (preferably within the range of 68.5 °C to 71.5 °C), continuous removal is achieved, thereby shifting the equilibrium towards complete conversion of the isopropyl alcohol. This method, reminiscent of techniques taught by Skinner, ensures a high purity di-isopropyl ether intermediate for subsequent processing.

### B. Oxidation Module

The di-isopropyl ether is transferred to an oxidation reactor maintained at a temperature within the range of 25 °C to 30 °C (preferably within the range of 26 °C to 29 °C). Ambient air is sparged into the reactor at a rate between 8 mL/min and 12 mL/min (preferably 10 mL/min) to supply the necessary oxygen. A catalyst system is then introduced comprising:
a. Cobalt Salts: For example, acidified cobalt nitrate at an effective concentration of 0.2 mM to 0.5 mM (preferably 0.25 mM to 0.3 mM).
b. Manganese Salts: For example, manganese(II) acetate at an effective concentration of approximately 0.25 mM.
c. Halide Additive: For example, sodium iodide at an effective concentration of 0.1 mM to 0.3 mM (preferably 0.1 mM to 0.2 mM).

In one preferred embodiment, the oxidation module is augmented by the incorporation of an ultraviolet photoinitiation means. A quartz mercury UVC lamp is positioned adjacent to or integrated within the oxidation reactor. The UVC radiation, in addition to conventional thermal and oxygen activation, serves to promote the dissociation of dioxygen into atomic oxygen and facilitates the formation of reactive oxygen species via subsequent reactions with the catalyst. The resulting reactive oxygen species act as rapid initiators for the free-radical chain oxidation of di-isopropyl ether, thereby enhancing the reaction rate and early-stage conversion. The lamp may be operatively coupled to the reactor via a controlled power source, ensuring that irradiation is delivered only during the initial phase of the oxidation reaction to attain optimum initiation without adversely affecting subsequent reaction steps.

Under these controlled conditions, the di-isopropyl ether is oxidized via a free-radical chain mechanism to form a hydroperoxide intermediate. The selection of catalysts and the moderate operating conditions (lower than many conventional processes) minimize side reactions and undesired byproduct formation.

### C. Hydrolysis Module

Immediately following the oxidation stage, the hydroperoxide intermediate is hydrolyzed by the controlled, dropwise addition of deionized water. The water addition is controlled such that the total water introduced per 10 mL reaction mixture is maintained within the range of 0.5 mL to 1.0 mL (preferably 0.75 mL). The hydrolysis reaction is performed under a mildly acidic environment, with the pH adjusted and maintained within the range of 4 to 5 (preferably within the range of 4.2 to 4.8). These conditions promote the rapid conversion of the hydroperoxide intermediate to hydrogen peroxide while suppressing further side reactions.

### D. Separation and Recovery Module

Following hydrolysis, the reaction mixture separates into two immiscible phases: an organic phase containing residual di-isopropyl ether and an aqueous phase enriched in hydrogen peroxide. The mixture is allowed to settle, and the aqueous phase is separated by decantation or by using a separatory funnel. If a higher concentration of hydrogen peroxide is desired, the aqueous phase can be further concentrated by low-temperature evaporation under reduced pressure. In addition, residual catalyst materials can be recovered by adjusting the pH to precipitate metal hydroxides, which may then be recycled. This approach enhances overall process efficiency and lowers waste.

### E. Advantages and Improvements

The sequential modular process of the present invention offers several distinct advantages:
1. Improved Selectivity: By using di-isopropyl ether as the intermediate and decoupling the oxidation and hydrolysis steps, the formation of undesired byproducts such as acetone and isopropanol is significantly reduced, compared to prior art methods (cf. Skinner, Bonetti, Rosenthal).
2. Enhanced Conversion: Continuous removal of the intermediate drives the reaction equilibrium to favor complete conversion.
3. Milder Operating Conditions and Better Control: Operating the oxidation module at temperatures as low as 25 °C to 30 °C ensures reduced thermal decomposition, offering superior control over reaction kinetics.
4. Field-Deployable, Low-Capital Design: The process utilizes straightforward, readily available equipment that is particularly suitable for decentralized production.
5. Catalyst Recovery: The incorporation of pH adjustment for catalyst recovery further improves the overall efficiency and sustainability of the process.

Moreover, the comprehensive studies in the Burgess article emphasize the importance of controlled reaction conditions—including the effects of temperature, contact time, and vessel surface—principles that are harnessed and enhanced in the present invention.

### Conclusion

The present invention discloses a continuous, sequential modular process for producing hydrogen peroxide from di-isopropyl either. By employing di-isopropyl ether as an intermediate—and by separating the overall process into distinct feedstock synthesis, oxidation, hydrolysis, and recovery modules operating under carefully controlled conditions—the invention achieves improved efficiency and selectivity for hydrogen peroxide while significantly reducing the formation of byproducts. The operational parameters, including temperature ranges, catalyst concentrations, water dosage, and pH control, are optimized to overcome the limitations observed in prior methods, as discussed in U.S. Pat. Nos. 4,547,354; 3,737,518; 3,891,748; 3,871,103; and in the work of A. R. Burgess.

This detailed description and the associated claims are intended to clearly disclose the best mode of the invention without unduly limiting its scope.

1. A process for producing hydrogen peroxide, comprising:
(a) generating di-isopropyl ether from isopropyl alcohol by acid-catalyzed dehydration in a feedstock synthesis module, the di-isopropyl ether being continuously separated from the reaction mixture by distillation using a fractionating column;
(b) contacting the di-isopropyl ether in an oxidation module with a gas stream containing molecular oxygen at a temperature maintained within the range of 25 °C to 30 °C (preferably 26 °C to 29 °C) and at an oxygen flow rate within the range of 8 mL/min to 12 mL/min (preferably 10 mL/min), in the presence of a catalyst system comprising:
(i) cobalt salts at an effective concentration within the range of 0.2 mM to 0.5 mM (preferably 0.25 mM to 0.3 mM, e.g., 0.25 mM Co(II));
(ii) manganese salts at an effective concentration within the range of 0.2 mM to 0.5 mM (preferably 0.25 mM, when used in combination with Co(II)); and
(iii) a halide additive at an effective concentration within the range of 0.1 mM to 0.3 mM (preferably 0.1 mM to 0.2 mM);
(iv) optionally further irradiating the reaction mixture with ultraviolet light from a quartz mercury UVC lamp configured to generate reactive oxygen species to enhance the initiation of the autooxidation reaction;
(c) forming a hydroperoxide intermediate from the di-isopropyl ether by autooxidation;
(d) hydrolyzing the hydroperoxide intermediate in a hydrolysis module by controlled, dropwise addition of water, the total volume of water added per 10 mL of reaction mixture being within the range of 0.5 mL to 1.0 mL (preferably 0.75 mL), under conditions wherein the pH is maintained within the range of 4 to 5 (preferably 4.2 to 4.8), thereby converting the hydroperoxide intermediate to hydrogen peroxide; and
(e) separating an aqueous phase enriched in hydrogen peroxide from residual di-isopropyl ether.

2. The process of claim 1, wherein the oxidation module is further equipped with an ultraviolet photoinitiation means, comprising a quartz mercury UVC lamp arranged to irradiate the reaction mixture and generate reactive oxygen species, thereby enhancing the initiation and rate of di-isopropyl ether autooxidation.

3. The process of claim 1, wherein the acid-catalyzed dehydration of isopropyl alcohol is carried out in the presence of concentrated sulfuric acid modified with acetic acid.

4. The process of claim 1, wherein the cobalt salts comprise acidified cobalt nitrate and the manganese salts comprise manganese(II) acetate.

5. The process of claim 1, wherein the halide additive is sodium iodide.

6. The process of claim 1, further comprising recovering residual metal catalysts from the reaction waste stream by adjusting the pH to precipitate metal hydroxides and recycling the precipitated catalysts.

7. The process of claim 1, wherein the aqueous phase enriched in hydrogen peroxide is further concentrated by low-temperature evaporation under reduced pressure.

8. A field-deployable system for producing hydrogen peroxide, comprising:
(a) a feedstock synthesis module configured to generate di-isopropyl ether from isopropyl alcohol by acid-catalyzed dehydration and continuous distillation using a fractionating column;
(b) an oxidation module configured to oxidize the di-isopropyl ether to a hydroperoxide intermediate by introducing a gas stream containing molecular oxygen at a rate within the range of 8 mL/min to 12 mL/min, at a temperature maintained within the range of 25 °C to 30 °C, in the presence of a catalyst system comprising cobalt salts, manganese salts, and a halide additive at effective concentrations as recited in claim 1 and further incorporating ultraviolet irradiation from a quartz mercury UVC lamp to generate reactive oxygen species for enhanced free radical reaction initiation;
(c) a hydrolysis module configured to convert the hydroperoxide intermediate to hydrogen peroxide by controlled, dropwise addition of water, the water being added in an amount within the range of 0.5 mL to 1.0 mL per 10 mL reaction volume and under conditions wherein the pH is maintained within the range of 4 to 5; and
(d) a separation module configured to isolate an aqueous phase enriched in hydrogen peroxide from a residual di-isopropyl ether phase; wherein the entire system is adapted for continuous operation under field-deployable, low-capital conditions.
